(19) United States
(12) Patent Application Publication
(10) Pub. No.: US 2011/0090833 A1
(43) Pub. Date: Apr. 21, 2011

(54) GROUP ADDRESSED FRAME DELIVERY IN WIRELESS NETWORKS

(75) Inventors: Jarkko KNECKT, Espoo (FI); Mika KASSLIN, Espoo (FI); Janne MARIN, Espoo (FI)

(73) Assignee: NOKIA CORPORATION, Espoo (FI)

(21) Appl. No.: 12/603,174

(22) Filed: Oct. 21, 2009

(51) Int. Cl. H04H 20/71

(52) U.S. Cl. 370/312

(57) ABSTRACT

Method, apparatus, and computer program product embodiments are disclosed to improve power conservation and efficiency in wireless mesh networks, by limiting the number of sources of group addressed frames that a peer mesh station receives. In an example embodiment of the invention, a portal wireless peer mesh device transmits a Portal Announcement frame in a wireless mesh network to create unidirectional paths from wireless mesh devices within the network to the portal. The Portal Announcement frame is relayed from one wireless peer mesh device to another to flood the network. Each wireless peer mesh device that receives the Portal Announcement frame receives the network address of the portal and the network address of the wireless peer mesh device that transmitted the frame to the receiving transmitting device. The receiving device may have received a plurality of Portal Announcement frames from a plurality of transmitting devices. A first, receiving wireless mesh device selects a second, transmitting wireless mesh device of the plurality of transmitting wireless mesh devices to be the sole transmitting source from which the first receiving wireless mesh device will receive group addressed messages. The first wireless mesh device transmits a group delivery notify message to the second wireless peer mesh device informing of the second device of its selection as the sole transmitting source of group addressed messages for the first device. Thereafter, the first wireless mesh device receives only from the second wireless peer mesh device, group addressed messages.

### FIELD

The embodiments relate to wireless communication, and more particularly to a network communication procedure for group addressed communication in wireless networks.

### BACKGROUND

Wireless communication devices continue to proliferate due, in part, to technological advances that have improved both Quality of Service (QoS) and functionality. As a result, these devices have become commonplace for both personal and business use, allowing users to transmit and receive voice, text, and graphical data from various locations. The wireless networks by which these exchanges may be executed span different frequencies and ranges.

For example, in IEEE 802.11s networks, a wireless distribution system (DS) to which an access point (AP) connects may be replaced by a mesh of interoperable wireless links or multi-hop paths. End stations may establish interoperable peer-to-peer wireless links with neighboring end stations and APs in an 802.11 wireless mesh network. Mesh Stations (mesh STAs) may support mesh services, i.e. they participate in interoperable formation and operation of a Mesh Basic Service Set (MBSS). A mesh basic service set (MBSS) is a basic service set (BSS) that forms a self-contained network of mesh stations (mesh STAs), and which may be used as a distribution system (DS). The configuration of a mesh STA that is collocated with an Access Point allows a single device to logically provide both mesh functionalities and AP functionalities simultaneously.

IEEE 802.11s networks are described in the IEEE P802.11s™/D3.03 Draft Standard for Information Technology-Telecommunications and information exchange between systems-Local and metropolitan area networks-Specific requirements-Part 11: Wireless LAN Medium Access Control (MAC) and Physical Layer (PHY) specifications Amendment 10: Mesh Networking, dated July 2009, which is incorporated herein by reference.

### SUMMARY

Method, apparatus, and computer program product embodiments are disclosed to improve power conservation and efficiency in wireless mesh networks, by limiting the number of sources of group addressed frames that a peer mesh station receives. In an example embodiment of the invention, a portal wireless peer mesh device transmits a Portal Announcement frame in a wireless mesh network to create unidirectional paths from wireless mesh devices within the network to the portal. The Portal Announcement frame is relayed from one wireless peer mesh device to another to flood the network. Each wireless peer mesh device that receives the Portal Announcement frame receives the network address of the portal and the network address of the wireless peer mesh device that transmitted the frame to the receiving device. This establishes a hierarchy among the wireless peer mesh devices in the network between a next preceding device transmitting the Portal Announcement frame and its receiving device, with the receiving device being lower in the hierarchy than the transmitting device. The receiving device may have received a plurality of Portal Announcement frames from a plurality of transmitting devices. A first, receiving wireless mesh device makes use of the network hierarchy to select a second, transmitting wireless mesh device of the plurality of transmitting wireless mesh devices to be the sole transmitting source from which the first receiving wireless mesh device will receive group addressed messages. The first receiving device is lower in the hierarchy than the second transmitting device. The first wireless mesh device transmits a group delivery notify message to the second wireless peer mesh device informing of the second device of its selection as the sole transmitting source of group addressed messages for the first device. Thereafter, the first wireless mesh device receives only from the second wireless peer mesh device, group addressed messages. The first wireless mesh device ignores group addressed messages from other devices in the network not selected to be a sole transmitting source to the first device. If the first device operates in power save mode, it wakes up for the Delivery Traffic Indication Message (DTIM) Beacons and subsequent group addressed messages from the second device.

The first device is responsible for transmitting to the second device group addressed messages that it has originated itself. Also, the first device is responsible to transmit group addressed messages to a third wireless mesh device that is lower in the hierarchy in the network, which has selected the first device to be the sole transmitting source from which the third wireless mesh device will receive group addressed messages. Since the first wireless mesh device receives a group delivery notify message from the third device, the first device stops ignoring group addressed messages received from the third device. The first device is responsible for forwarding to the second device group addressed messages that it has received that were originated by the third device.

In an example embodiment of the invention, the selection may be based on the quality of the communication path between the first device and the second device. In another example embodiment of the invention, the selection may be based on the next adjacent wireless peer mesh device along the path toward the portal device in the network.

In an example embodiment of the invention, the group addressed frames are group addressed (multicast/broadcast) frame communication in an IEEE 802.11s wireless mesh network.

An example embodiment of the invention performs the steps comprising:

receiving at a first wireless peer mesh device in a wireless mesh network, a portal announcement frame that includes a network address of a portal device in the network and a network address of a second wireless peer mesh device in the network that transmitted the frame to the first device;

selecting with the first device the second device to be a sole transmitting source from which the first device will receive group addressed messages;

transmitting by the first device a group delivery notify message to the second device informing the second device of its selection as the sole transmitting source of group addressed messages for the first device;

receiving at the first device from the second device, group addressed messages; and

ignoring group addressed messages from other devices in the network not selected to be a sole transmitting source to the first device.

Another example embodiment of the invention performs the steps comprising:

receiving at the first device a group delivery notify message from a third wireless mesh device in the network, which has selected the first device to be a sole source from which the third device will receive group addressed messages;

stopping ignoring group addressed messages received by the first device from the third device in response to receiving the group delivery notify message from the third device;

transmitting by the first device to the third device, group addressed messages moving in a direction away from the portal device; and

receiving at the first device from the third device group addressed messages that the third device has originated or which are moving in the direction toward the portal device and forwarding those group addressed messages to the second device.

Another example embodiment of the invention performs the steps comprising:

receiving at a second wireless peer mesh device in a wireless mesh network, from a first wireless peer mesh device in the network, a group delivery notify message informing the second device of its selection as a sole transmitting source of group addressed messages for the first device;

stopping ignoring group addressed messages received by the second device from first device;

transmitting from the second device to the first device, group addressed messages;

receiving at the second device from the first device group addressed messages that the first device has originated, and

forwarding the group addressed messages originated by the first device, to another wireless peer mesh device in the network that the second device has selected as its sole source for group addressed messages.

In this manner power conservation and efficiency are improved in wireless mesh networks.

### DESCRIPTION OF THE FIGURES

FIG. 1 illustrates an example embodiment of a wireless mesh device 206.

FIG. 2A illustrates an example embodiment of an IEEE 802.11s wireless mesh network, wherein example portal announcement (PANN) frames flood through the network.

FIG. 2B illustrates an example embodiment of an IEEE 802.11s wireless mesh network of FIG. 2A, wherein each wireless peer mesh device that receives the group addressed Portal Announcement frame receives the network address of the portal and the network address of the wireless peer mesh device that transmitted the frame to the receiving device.

FIG. 2C illustrates an example embodiment of an IEEE 802.11s wireless mesh network of FIG. 2A, wherein a receiving first wireless mesh device selects a transmitting second wireless mesh device with the best link quality, to be its sole transmitting source from which the receiving first wireless mesh device will receive group addressed messages.

FIG. 2D illustrates an example embodiment of an IEEE 802.11s wireless mesh network of FIG. 2A, wherein the first wireless mesh device transmits a group delivery notify message to the second wireless peer mesh device informing of the second device of its selection as the sole transmitting source of group addressed messages for the first device.

FIG. 2E illustrates an example embodiment of an IEEE 802.11s wireless mesh network of FIG. 2A, wherein the first device receives group addressed messages only from the selected second device and based on the selection, ignores group addressed messages from other devices.

FIG. 2F illustrates an example embodiment of an IEEE 802.11s wireless mesh network of FIG. 2A, wherein a third wireless mesh device, which is lower in the hierarchy, transmits a group delivery notify message to the first device informing of the first device of its selection as the sole transmitting source of group addressed messages for the third device.

FIG. 2G illustrates an example embodiment of an IEEE 802.11s wireless mesh network of FIG. 2A, wherein the first device stops ignoring group addressed messages received from the third device in response to receiving the group delivery notify message from the third device that is lower in the network hierarchy.

FIG. 2H illustrates an example embodiment of an IEEE 802.11s wireless mesh network of FIG. 2A, wherein the first device receives group addressed messages from the second device and transmits group addressed messages to the third device that is lower in the network hierarchy.

FIG. 2I illustrates an example embodiment of an IEEE 802.11s wireless mesh network of FIG. 2A, wherein the first device is responsible for transmitting to the second device group addressed messages that it has originated itself.

FIG. 2J illustrates an example embodiment of an IEEE 802.11s wireless mesh network of FIG. 2A, wherein the first device is responsible for transmitting to the second device group addressed messages that it has received that were originated by the third device.

FIG. 3 illustrates an example embodiment of a flow diagram 300 for the process in an example wireless mesh device selecting an exclusive source of group addressed frames.

FIG. 4 illustrates an example embodiment of a flow diagram 400 for the process in a wireless mesh device in a wireless mesh network for being a selected source of group addressed frames to a receiving device having done the selecting.

FIG. 5 is an example timing diagram illustrating awake periods of a wireless mesh device operating without benefit of at least one embodiment of the invention and operating with benefit of at least one embodiment of the invention enabling it to be awake only for the Delivery Traffic Indication Message (DTIM) Beacons and subsequent group addressed messages from its selected source of the group addressed messages.

### DISCUSSION OF EXAMPLE EMBODIMENTS

A wireless mesh network consists of nodes or devices capable of wirelessly connecting to each other via one or more wireless links. Nodes and/or devices belonging the mesh network may be called mesh stations (mesh STAs). All mesh STA devices may have the same capability. Each mesh STA is capable of forwarding traffic. Each mesh STA may transmit Beacons as per beacon interval determined by each mesh STA individually. Mesh STAs may authenticate each other and provide a means to establish and manage links and peerings between mesh STAs. Peering is a logical relationship between two neighboring mesh STAs. A mesh network operates on the medium access control (MAC)-level and may operate as a bridge. Data type frame transmissions occur in links that a mesh STA establishes with neighbor mesh STAs. A link is a result of a peering in which two neighboring mesh STAs authenticate each other. Actual data delivery occurs across paths that are established on top of links. Paths are either single-hop or multi-hop paths depending on the number of links along the path. Any higher layer, e.g. the internet protocol (IP) layer for networking, may consider a mesh network as a single hop and does not need to be aware of mesh operations.

A logical peering relationship may be established from one mesh STA to another mesh STA with a mesh peering management protocol. Mesh STAs may participate with other mesh STAs in mesh functionalities such as path selection and forwarding. Mesh STAs may propagate mesh frames over multiple hops and connectivity is provided to all member STAs.

Mesh portals interface the mesh network to other IEEE 802 LAN segments. A Portal Announcement (PANN) element is used to announce the presence of a mesh STA collocated with a portal in the mesh BSS. Portal Announcements allow mesh STAs to select the appropriate portal and build a path towards it. Portals may learn the addresses of the mesh STAs and of devices attached to these mesh STAs through the receipt of path selection messages. A mesh STA that receives a Portal Announcement message may propagate the Portal Announcement to neighboring STAs.

Data transmission occurs at the link layer using mesh paths that are formed out of links. Link and peering can be established only to a mesh STA from which Beacon frames can be received. Each mesh STA is responsible for participating in all the functionality essential for multi-hop data delivery in the mesh network. Data is forwarded across the paths between mesh STAs. At the link layer, data can be transmitted either in individually addressed frames or in group addressed data frames. When mesh STAs are in active mode, the addressing mode has very little, if any, influence on frame transmissions. The biggest general difference is that there is no acknowledgement (ACK) scheme for group addressed frames at the link layer. Use of power save complicates the situation and there are specific rules for both individually addressed and group addressed frame transmissions with power save.

The IEEE 802.11s power save builds on two operation modes in a manner similar to Basic Service Set (BSS) and Independent Basic Service Set (IBSS) defined in IEEE 802.11 standards in general. Active mode: Mesh STA is always on. Power save mode: Mesh STA saves power and uses power save features to be occasionally in doze state and off the channel. Power save comprises of two feature sets: Support for power save and Operation in power save.

The feature set of support for power save includes capability to buffer frames and track mesh power mode of each peer mesh STA. Individually addressed frames are transmitted to a peer mesh STA in power save mode when the peer mesh STA is in awake state. Awake state periods are called peer service periods and they are similar to the service periods in QoS-BSS networks. If the peer mesh STA is in active mode, a transmitting mesh STA can transmit individually addressed frames at any time as long as the normal channel access and transmission rules are obeyed. If any of a mesh STA's peer mesh STAs is in power save mode, group addressed frames are transmitted after a transmitting mesh STA's own Delivery Traffic Indication Message (DTIM) Beacon frame. If all the peer mesh STAs are in active mode, a transmitting mesh STA can transmit group addressed frames at any time. A Delivery Traffic Indication Message is a Traffic Indication Message (TIM), which informs the recipient of the presence of buffered data at the sender. It is generated within the periodic beacon at a frequency specified by the DTIM Interval. Normal Traffic Indication Messages (TIM) that are present in every beacon are for signaling the presence of buffered unicast data.

Every beacon has a TIM element that is used to indicate presence of buffered individually addressed frames to a peer device. The TIM element contains a bitmap in which one bit represents one device and if the bit is set to 1 that means that there is individually addressed frames buffered for that device. TIM elements are periodically DTIM elements, as per the DTIM Period value. In every TIM field there are DTIM Count and DTIM Period values that indicate how often the TIM element is a DTIM element and whether this TIM element is a DTIM element (DTIM Count=0) or whether it is just a normal TIM element (DTIM Count=non-zero value). In the DTIM element, one bit in the Bitmap Control field is used to indicate whether the device that transmitted the beacon has group addressed frames buffered. If there are, the device will transmit the buffered group addressed frames after the DTIM Beacon.

A transmitting mesh STA that has at least one peer mesh STA in power save transmits group addressed frames in any/random order after transmitting a DTIM Beacon. At the receiver, a power saving mesh STA listens to all the group addressed frames from its all peer mesh STAs.

The delivery of group addressed frames in IEEE 802.11s mesh networks relies on a flooding principle, where each device receives all multicast transmissions from all peer mesh STAs and transmits multicast transmissions at least once.

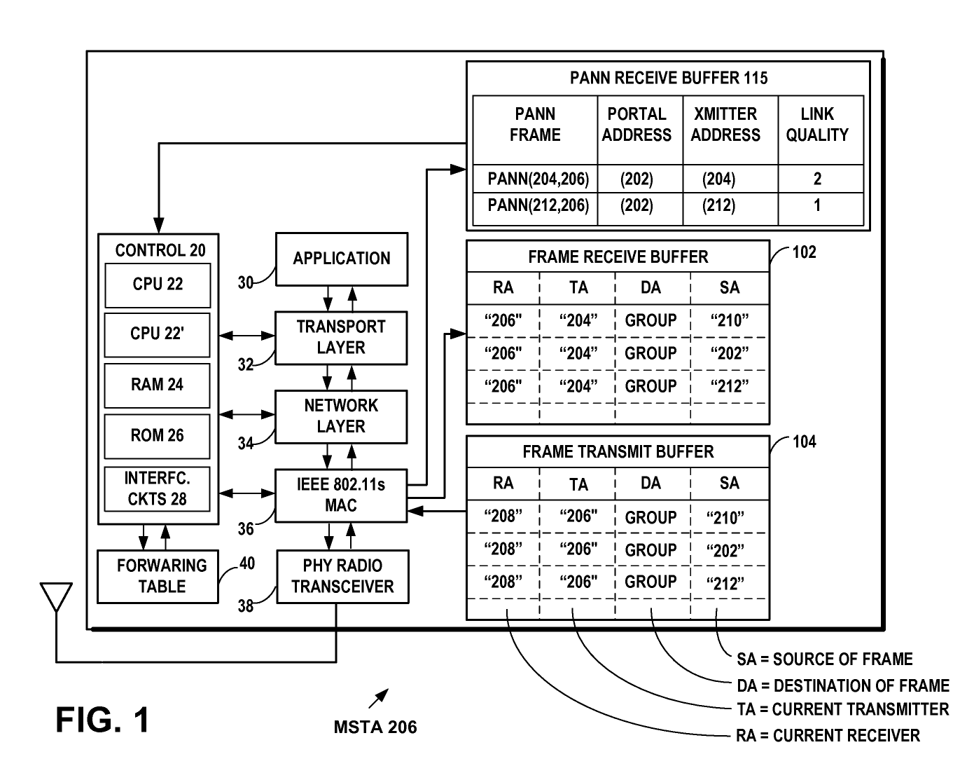

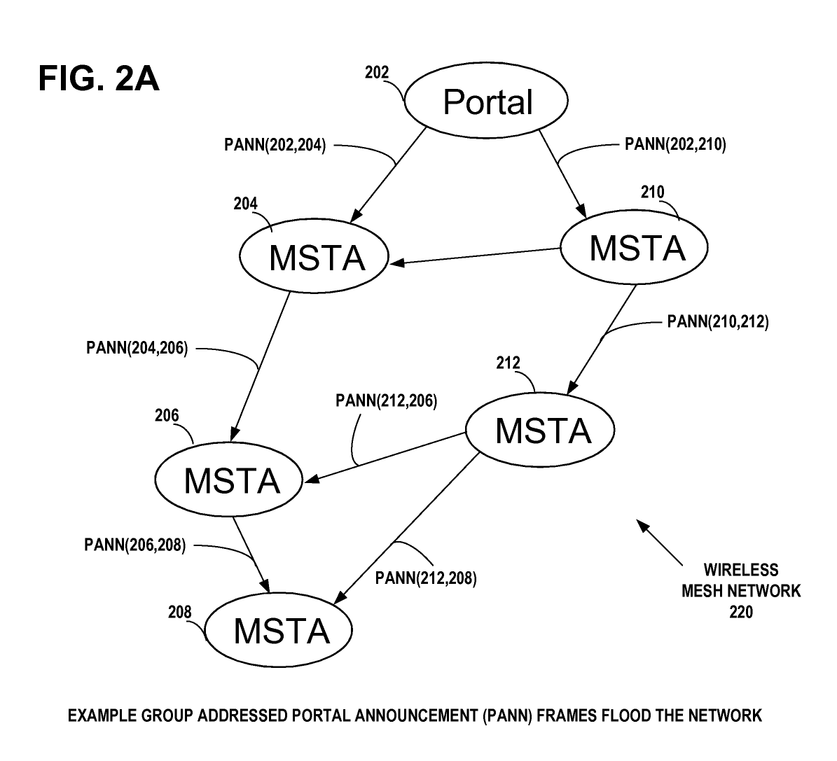

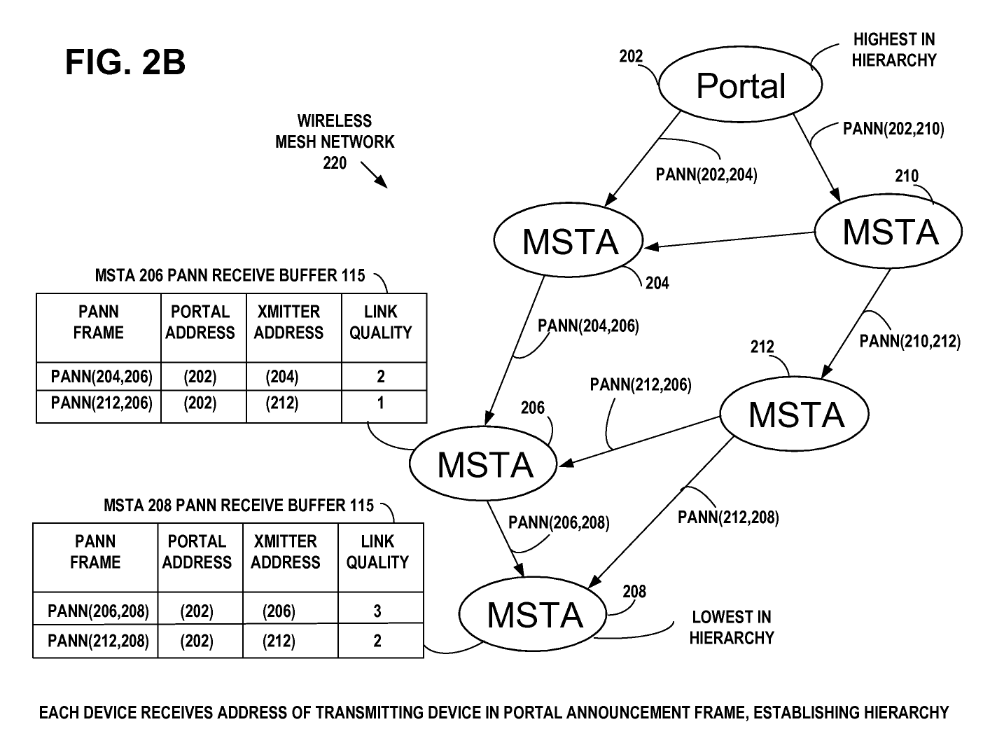

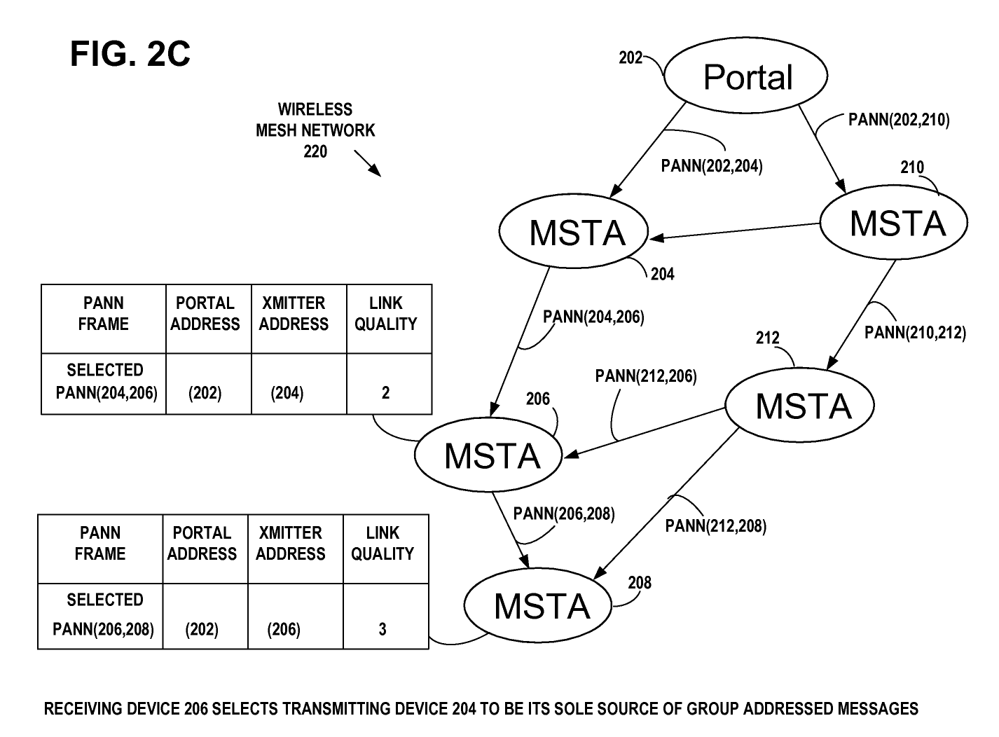

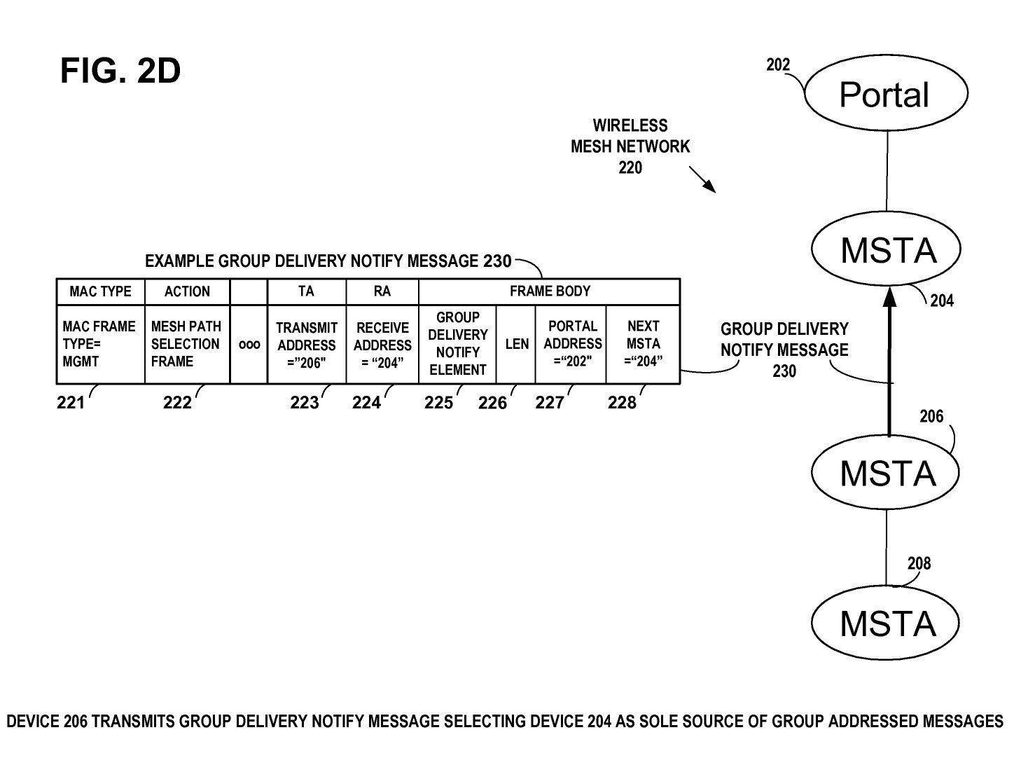

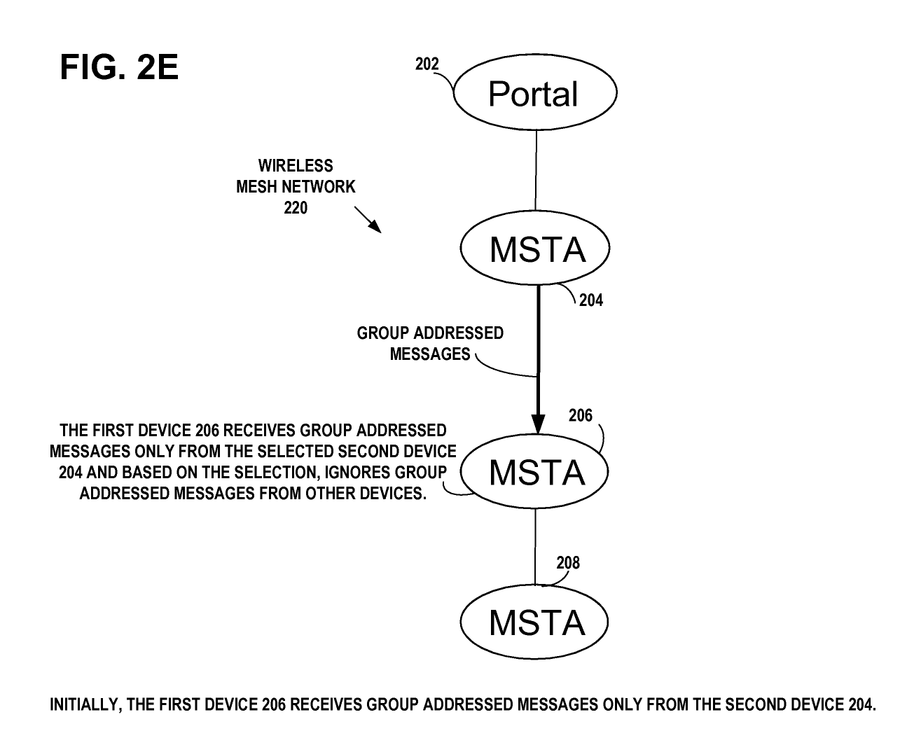

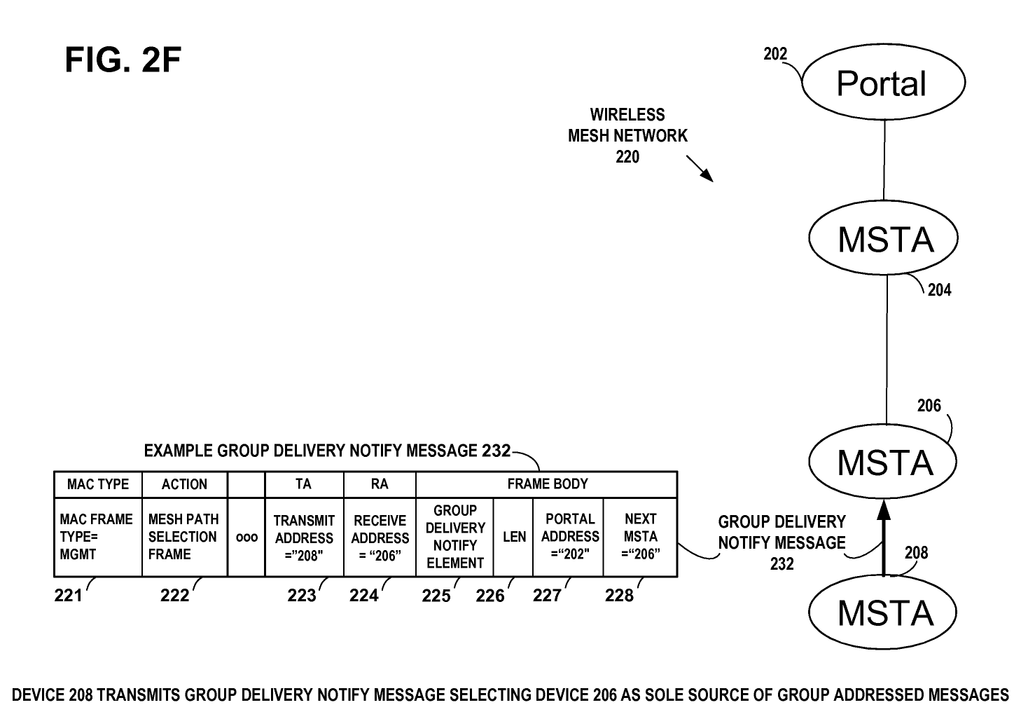

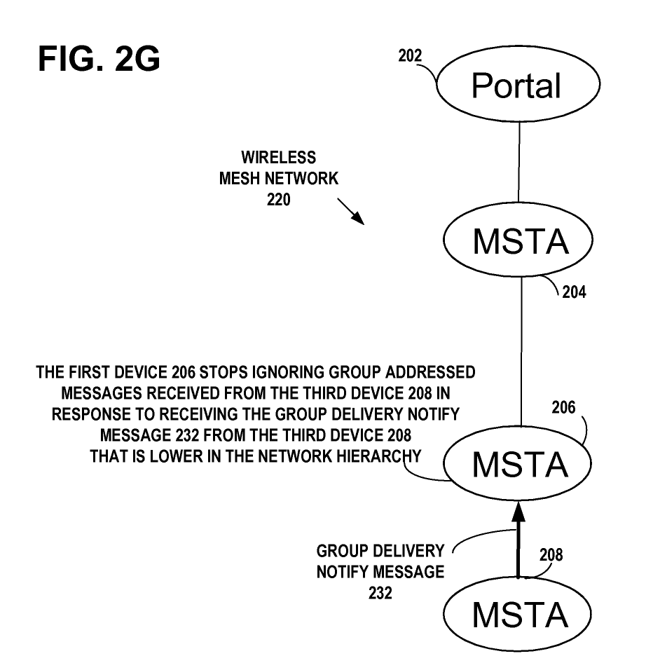

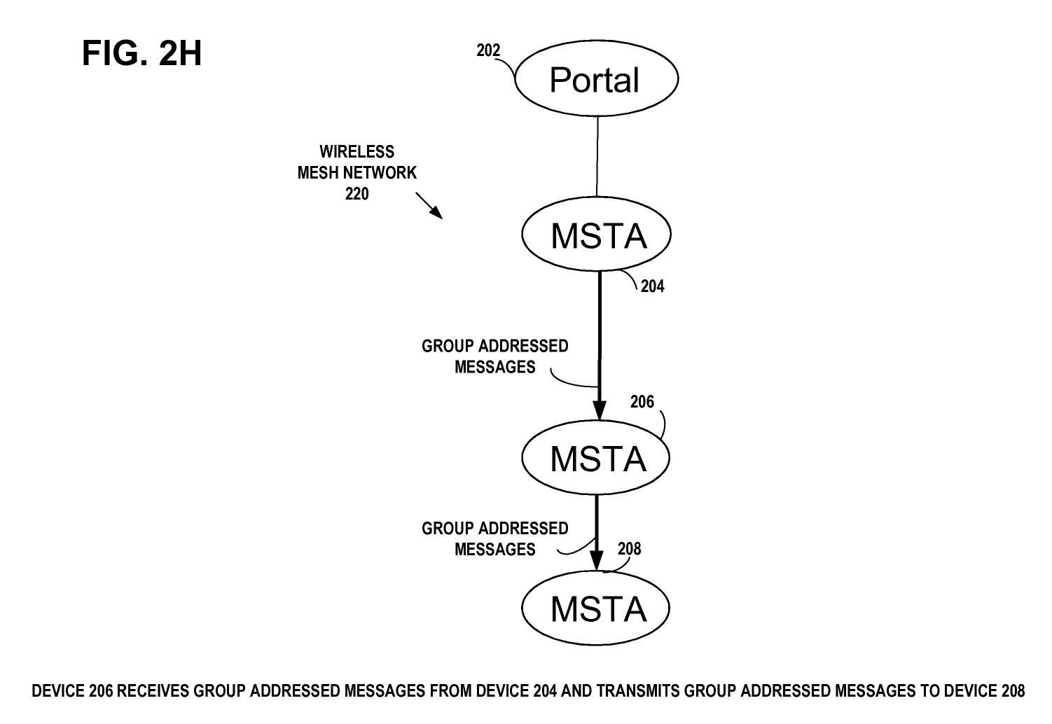

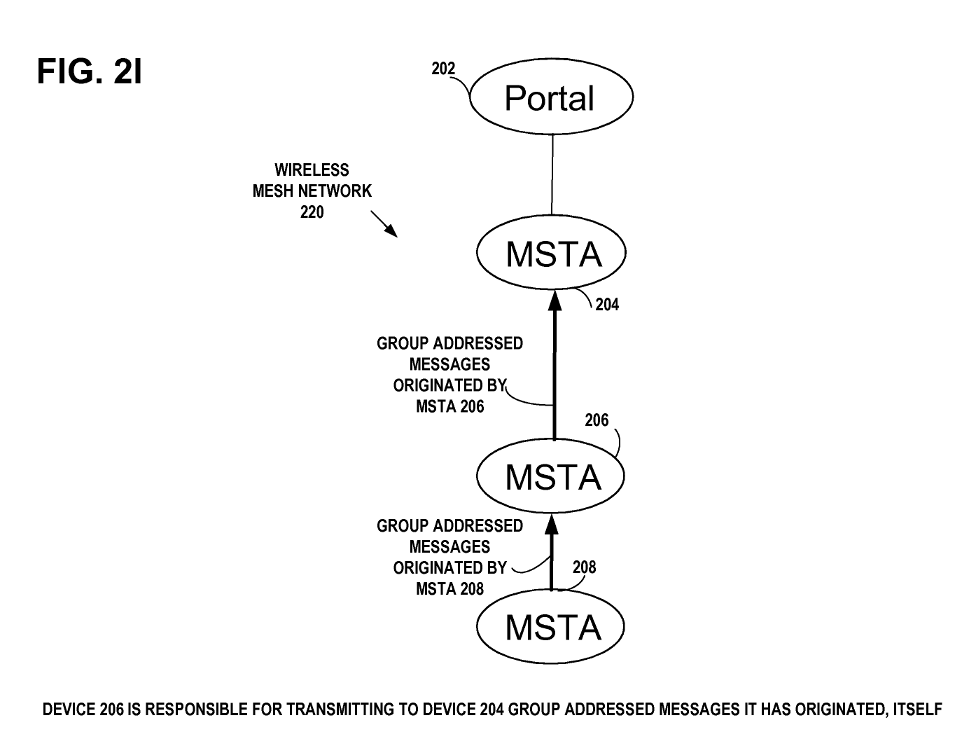

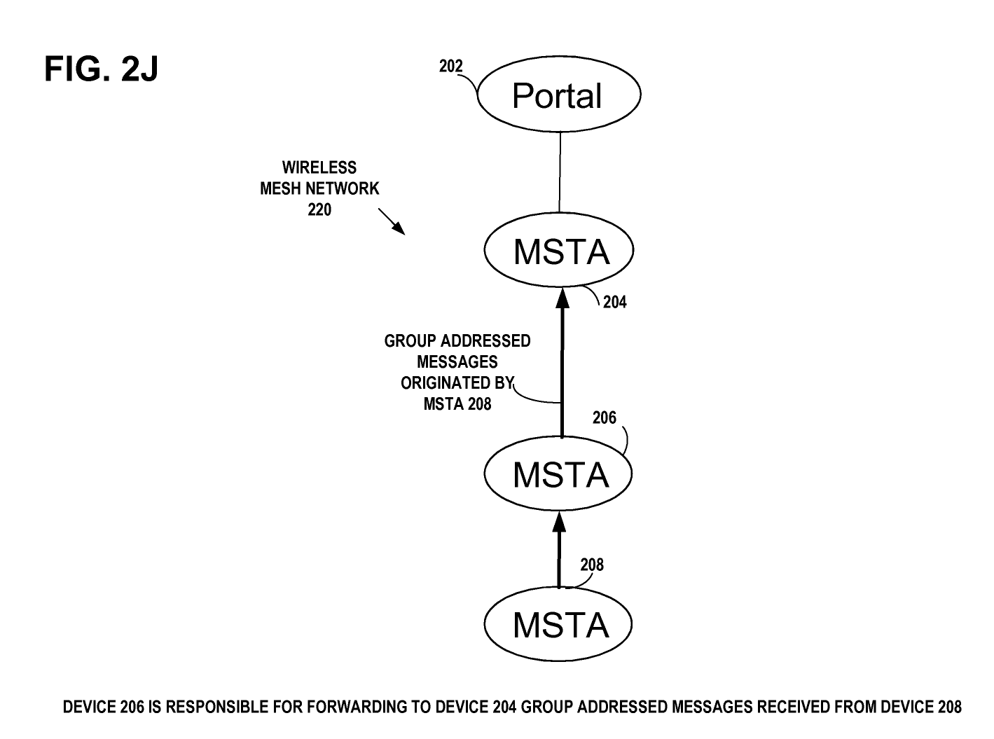

FIG. 1 illustrates an example embodiment of a wireless mesh device MSTA 206 in an example embodiment of an IEEE 802.11s wireless mesh network 220 shown in FIG. 2A. The wireless mesh device MSTA 206 includes a control module 20 that includes a dual core central processing unit (CPU) 22 and 22′, a random access memory (RAM) 24, a read only memory (ROM) or programmable read only memory (PROM) 26, and interface circuits 28 to interface with forwarding table 40, a key pad, display, optional microphone, speakers, ear pieces, and camera or other imaging devices, etc. The several wireless mesh devices 204, 208, 210, and 212 shown in the network of FIG. 2A may each have substantially the same organization and components shown for the wireless mesh device MSTA 206 of FIG. 1. The dual core CPU processors 22 and 22′ are programmed with computer program instructions stored in the memory RAM 24 and ROM 26, to operate in conjunction with the IEEE 802.11s wireless mesh network MAC 36 and the transceiver 38 to perform the operations of the example embodiments.

IEEE 802.11s defines a communication protocol for WLAN based mesh networking where there is no single control point for the network. A specific portal node is responsible for initiating various control messaging within the network and serves as an access node to the external network. The basis for 802.11s networking is that nodes communicate with other peer nodes in the network over direct wireless links that are not controlled by any other nodes. Further, all nodes transmit beacons on beacon interval and nodes indicate in the beacons their presence in the network. The portal node also initiates specific Portal Announcement (PANN) frames to create unidirectional paths from within the network (to the portal node) and distribute availability information within the network.

Group addressed frames in the IEEE 802.11s standard utilize flooding for distributing the group addressed frames. This may create unnecessary transmissions of the group addressed frames within the network, which may impose unnecessary overhead and increased awake times for the network nodes, since the devices need to listen to the repetitive group addressed frames. This unnecessary overhead is resolved by the example embodiments of the invention.

A mesh STA that is the source of a group addressed frame may use a three-address group addressed frame, wherein Address 3 may be set to the group address, and Address 2 may be set to the mesh STA's own MAC address. On receipt of a frame with a group address, a mesh STA may set Address 2 to its own MAC address and the frame is queued for transmission to neighboring STAs.

The Hybrid Wireless Mesh Protocol (HWMP) is a mesh path selection protocol that combines the flexibility of on-demand path selection with proactive topology tree extensions. HWMP supports two modes of operation depending on the configuration. These modes provide different levels of functionality, the on demand mode and the proactive tree building mode. In the on demand mode, the functionality of this mode is always available. It allows mesh STAs to communicate using peer-to-peer paths. The mode is used in situations where there is no root mesh STA configured. It is also used if there is a root mesh STA configured and an on demand path may provide a better path to a given destination in the mesh. The proactive tree building mode is an additional functionality that may be added to the on demand mode.

IEEE 802.11s wireless mesh network MAC 36, processor control 20, and transceiver 38 of FIG. 1 are configured to receive individually addressed and group addressed frames in the frame receive buffer 102 from other wireless mesh devices in the wireless mesh network 220. The frame receive buffer 102 includes fields RA for the address of the current receiver, TA for the address of the current transmitter, DA for the destination of the frame, and SA for the source of the frame. The frame receive buffer 102 is shown having received three group addressed frames. The first Group addressed frame is received by mesh MSTA 206 from mesh device MSTA 204, having the destination of the frames DA=Group and having the source of the frames SA=MSTA 210. The second Group addressed frame is received by mesh MSTA 206 from mesh device MSTA 204, having the destination of the frames DA=Group and having the source of the frames SA=the portal device 202. The third Group addressed frame is received by mesh MSTA 206 from mesh device MSTA 204, having the destination of the frames DA=Group and having the source of the frames MSTA 212.

IEEE 802.11s wireless mesh network MAC 36, processor control 20, and transceiver 38 of FIG. 1 are configured to transmit individually addressed and group addressed frames in the frame transmit buffer 104 to other wireless mesh devices in the wireless mesh network 220. The frame transmit buffer 104 includes fields RA for the address of the current receiver, TA for the address of the current transmitter, DA for the destination of the frame, and SA for the source of the frame. The frame transmit buffer 104 is shown with three group addressed frames. The frame transmit buffer 104 is shown with the group addressed frames transmitted to mesh device MSTA 208.

The wireless mesh device MSTA 206 of FIG. 1 is configured to receive a plurality of example wireless Portal Announcement (PANN) messages in the PANN receive buffer 115 relayed from other wireless mesh devices in the wireless mesh network 220 of FIG. 2A. The portal announcement (PANN) message is transmitted in a beacon or a Mesh Interworking action frame as a group addressed message that contains the Mesh Portal Address, which is a 48-bit MAC address set to the MAC address of the mesh STA that is collocated with the portal 202. The portal announcement (PANN) message frames flood through the network 220 distributing information of the availability of the portal 202 and creating unidirectional paths, from the various receiving MSTAs 204, 206, 208, 210, and 212 in the network to the portal 202.

FIG. 2B illustrates each wireless peer mesh device that receives the group addressed Portal Announcement frame receives the network address of the portal 202 and the network address of the wireless peer mesh device that transmitted the frame to the receiving device. This establishes a hierarchy among the MSTA devices in the network between a next preceding device transmitting the PANN message and its receiving device, with the receiving device being lower in the hierarchy than the transmitting device. The portal device 202 is highest in the hierarchy. For example, MSTA 206 receives PANN (204,206) from MSTA 204 with a link quality of 2, thus MSTA 204 is higher in the hierarchy than MSTA 206. MSTA 206 receives and PANN (212,206) from MSTA 212 with a link quality of 1, thus MSTA 212 is higher in the hierarchy than MSTA 206. As another example, MSTA 208 receives PANN (206,208) from MSTA 206 with a link quality of 3, thus MSTA 206 is higher in the hierarchy than MSTA 208. MSTA 208 receives PANN (212,208) from MSTA 212 with a link quality of 2, thus MSTA 212 is higher in the hierarchy than MSTA 208. The PANN receive buffer 115 of MSTA 206 in FIG. 1 includes fields for the PANN frame ID, the portal address for portal 202, the transmitter address for the address of the next preceding transmitter of the PANN message, and the link quality of the PANN message as received by the MSTA 206. The PANN receive buffer 115 is shown having received a PANN message PANN (204,206) from MSTA 204 with a link quality of “2” and a PANN message PANN (212,206) from MSTA 212 with a link quality of “1”. The link quality value of 2 of PANN message PANN (204,206) is better than the link quality value of 1 of PANN message PANN (212,206).

FIG. 2C illustrates the MSTA 206 selecting another peer MSTA device in the network, to be its sole transmitting source from which the MSTA 206 will receive group addressed messages. Embodiments of the invention make use of the hierarchy established by the flooding of the PANN messages among the MSTA devices in the network between a next preceding transmitter of the PANN message and its receiver. For example, MSTA 206 selects one of the MSTA devices 204 or 212 from which it has received a PANN message, as its sole transmitting source from which the MSTA 206 will receive group addressed messages. In an example embodiment, the MSTA 206 selects the MSTA 204 instead of MSTA 212, based on MSTA 204 having the better link quality. The CPU processors 22 and 22′, in conjunction with the IEEE 802.11s MAC 36 and transceiver 38 in MSTA 206, are configured to determine from the received PANN messages, which link has the better quality, resulting in the selection of MSTA 204, based on its better link quality. Similarly, MSTA 208 has received PANN (206,208) from MSTA 206 with a link quality of 3 and PANN (212,208) from MSTA 212 with a link quality of 2. Thus, MSTA 208 selects the MSTA 206 instead of MSTA 212, based on MSTA 206 having the better link quality.

FIG. 2D illustrates MSTA 206 transmitting an example group delivery notify message 230 to its selected peer MSTA 204 informing MSTA 204 of its selection as the sole transmitting source of group addressed messages for MSTA 206. The MSTA 206 uses a frame to inform peer MSTA 204 about its selection of group addressed frames transmitter. The frame may be new Group Delivery Notify Frame 230 or the Group Delivery information may be carried as one new information element of the Mesh Path selection frame. For clarity, the name Group Delivery Notify frame is used for both frame types, herein. The selection criterion for group addressed frames transmitter is the goodness of the path to portal, i.e. the path that has the best path metric.

The informing may be done according to at least two example embodiments:

1. In the first example embodiment, the example Group Delivery Notify frame 230 is transmitted by MSTA 206 to the peer MSTA 204 next in the path to portal 202. The receiver MSTA 204 of the Group Delivery Notify frame 230 will become the sole transmitter of group addressed data frames to the notifying MSTA 206. MSTA 204 will transmit all group addressed data frames to the notifying MSTA 206. The MSTA 204 may unicast or broadcast the group addressed data frames to MSTA 206, depending on the number of the peer mesh STAs in the network. FIG. 2E illustrates that initially, MSTA 206 receives only from MSTA 204, the group addressed messages moving in the direction away from the portal 202. Based on having made the selection of MSTA 204, MSTA 206 ignores group addressed messages from other devices in the network not selected to be a sole transmitting source to MSTA 206.

2. In the second example embodiment, the example Group Delivery Notify frame 230 is transmitted by MSTA 206 to all peer MSTAs 204, 208, 210, and 212 shown in the network of FIG. 2A. The Group Delivery Notify frame 230 contains the address of the selected transmitter MSTA 204 of the group addressed frames. The transmitter MSTA 204 has the same operation as described in the first example embodiment, as shown in FIG. 2E. Based on having made the selection of MSTA 204, MSTA 206 ignores group addressed messages from other devices in the network not selected to be a sole transmitting source to MSTA 206.

FIG. 2E illustrates an example embodiment of an IEEE 802.11s wireless mesh network of FIG. 2A, wherein the first device MSTA 206 receives group addressed messages only from the selected second device MSTA 204 and based on the selection, ignores group addressed messages from other devices.

FIG. 2F illustrates MSTA 208 transmitting an example group delivery notify message 232 to its selected peer MSTA 206 informing MSTA 206 of its selection as the sole transmitting source of group addressed messages for MSTA 208. The third device MSTA 208 is lower in the network hierarchy than MSTA 206. Thereafter, MSTA 208 receives only from MSTA 206, the group addressed messages. MSTA 208 ignores group addressed messages from other devices in the network not selected to be a sole transmitting source to MSTA 208.

The example group delivery notify messages 230 and 232 of FIGS. 2D and 2F are each included in a MAC management frame 221 as a mesh path selection frame 222 that includes a transmit address TA 223 and receive address RA 224. The frame body includes the group delivery notify element 225 that includes a length field 226, a portal address field 227, and a next MSTA address field 228 that identifies the selected MSTA.

TABLE 1
Group Delivery Notify frame using the structure of management action frame

| Order | Information | Note |
|---|---|---|
| 1 | Category | Set to Mesh Interworking |
| 2 | Action Value | Specific and unique value for Group |
| | | Addressed Frames Delivery Notification |
| 3 | MAC address of the | The MAC address of the mesh STA |
| | Portal/Root mesh STA | that operates in top of the hierarchy. |
| 4 | MAC address of the mesh | The MAC address of the mesh STA |
| | STA that is next in path to Portal/ | that is the next in the path to the Portal/Root |
| | Root mesh STA | mesh STA. Note, this field is present only in |
| | | embodiment 2. |
| 5 | Vendor Specific | One or more vendor-specific |
| | | information elements may appear in this |
| | | frame. This information element follows all |
| | | other information elements. |

TABLE 2
Group Delivery Notify information transmission by
using the Mesh Path Selection frame
The Group Delivery Notify element is shown below.
Group Delivery Notify element

| | | | MAC address of |
|---|---|---|---|
| | | | the mesh STA that |
| | | MAC address of the | is next in path to |
| Element ID | Length | Portal/Root mesh STA | Portal/ Root mesh STA |
| Octets: 1 | 1 | 6 | 6 |

The Group Delivery Information is one information element that may be transmitted as part of the Mesh Path Selection frame. The Mesh Path Selection frame is general carrier for path request, path reply, group delivery information and path error elements. One Group Delivery Information frame may contain one or more of these elements.

TABLE 3
The mesh Path Selection Frame is shown below.
Mesh Path Selection frame body

| Order | Information | Notes |
|---|---|---|
| 1 | Category | |
| 2 | Action | |
| 3 | Root Announcement | |
| | element (optional) | |
| 4 | Path Request element | |
| | (optional) | |
| 5 | Path Reply element | |
| | (optional) | |
| 6 | Path Error element | |
| | (optional) | |
| 7 | Group Delivery Notify | |
| | element (optional) | |
| Last | Vendor Specific | Optionally present: one or more vendor- |
| | | specific information elements. This |
| | | information element follows all other |
| | | information elements. |

FIG. 2G illustrates an example embodiment of an IEEE 802.11s wireless mesh network of FIG. 2A, wherein the first device MSTA 206 stops ignoring group addressed messages received from the third device MSTA 208 in response to receiving the group delivery notify message 232 from the third device MSTA 208 that is lower in the network hierarchy.

FIG. 2H illustrates an example embodiment of an IEEE 802.11s wireless mesh network of FIG. 2A, wherein the first device MSTA 206 receives group addressed messages from the second device MSTA 204, and transmits group addressed messages moving in the direction away from the portal to the third device MSTA 208, the third device MSTA 208 being lower in the network hierarchy than MSTA 206.

FIG. 2I illustrates that MSTA 206 is responsible for transmitting to MSTA 204 group addressed messages that MSTA 206 has originated, itself. FIG. 2J illustrates that MSTA 206 is responsible for forwarding to MSTA 204 group addressed messages moving in the direction toward the portal 202, that MSTA 206 has received that were originated by the third device MSTA 208. In embodiments, the notifier MSTA 206 will unicast to the selected peer MSTA 204 only the group addressed data frames that MSTA 206 has created and the group addressed data frames that it has received from its peer MSTA 208, since MSTA 208 has selected the MSTA 206 as the transmitter of group addressed data frames.

If any of the peer MSTAs in the network 220 has not transmitted or received a Group Delivery Notification frame 230 or a Mesh Path Selection frame that contains Group Delivery Notify element, that peer MSTA is not allowed to transmit or receive any group addressed data frames.

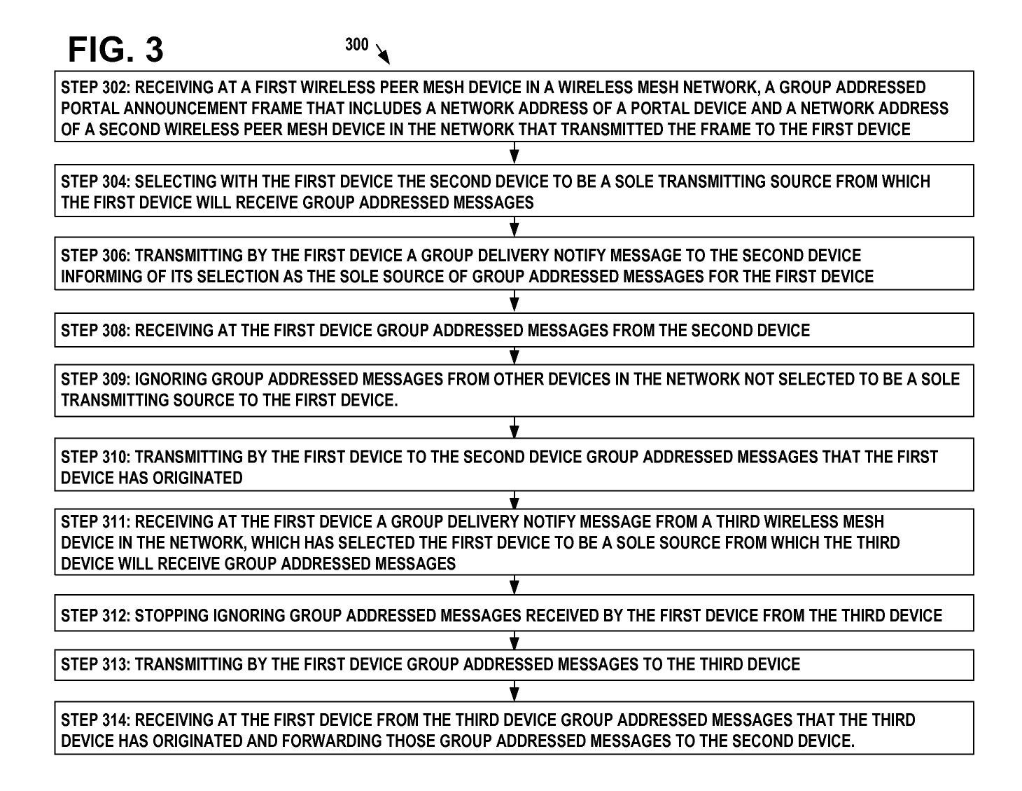

FIG. 3 illustrates an example embodiment of the flow diagram 300 of the process in an example wireless mesh device selecting an exclusive source of group addressed frames. The steps of the flow diagram represent computer code instructions stored in the memory 24 and 26 of a peer wireless mesh device, which when executed by the dual core central processing unit (CPU) 22 and 22′, carry out the functions of the example embodiments of the invention. The steps may be carried out in another order than shown and individual steps may be combined or separated into component steps.

The steps of the method 300 are as follows.

Step 302: receiving at a first wireless peer mesh device in a wireless mesh network, a portal announcement frame that includes a network address of a portal device in the network and a network address of a second wireless peer mesh device in the network that transmitted the frame to the first device;

Step 304: selecting with the first device the second device to be a sole transmitting source from which the first device will receive group addressed messages;

Step 306: transmitting by the first device a group delivery notify message to the second device informing the second device of its selection as the sole transmitting source of group addressed messages for the first device;

Step 308: receiving at the first device from the second device, group addressed messages;

Step 309: ignoring group addressed messages from other devices in the network not selected to be a sole transmitting source to the first device.

Step 310: transmitting by the first device to the second device group addressed messages that the first device has originated.

Step 311: receiving at the first device a group delivery notify message from a third wireless mesh device in the network, which has selected the first device to be a sole source from which the third device will receive group addressed messages

Step 312: stopping ignoring group addressed messages received by the first device from the third device;

Step 313: transmitting by the first device group addressed messages to the third device; and

Step 314: receiving at the first device from the third device group addressed messages that the third device has originated and forwarding those group addressed messages to the second device.

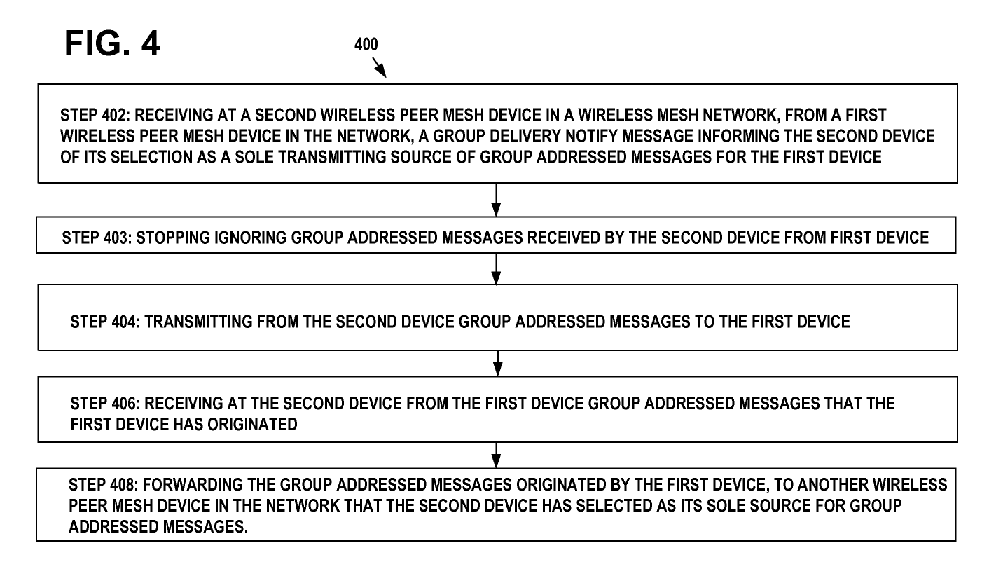

FIG. 4 illustrates an example embodiment of a flow diagram 400 for the process in an example wireless mesh device for being a selected source of group addressed frames to a receiving device that made the selection. The steps of the flow diagram represent computer code instructions stored in the memory 24 and 26 of a peer wireless mesh device, which when executed by the dual core central processing unit (CPU) 22 and 22′, carry out the functions of the example embodiments of the invention. The steps may be carried out in another order than shown and individual steps may be combined or separated into component steps.

The steps of the method 400 are as follows.

Step 402: receiving at a second wireless peer mesh device in a wireless mesh network, from a first wireless peer mesh device in the network, a group delivery notify message informing the second device of its selection as a sole transmitting source of group addressed messages for the first device;

Step 403: stopping ignoring group addressed messages received by the second device from first device;

Step 404: transmitting from the second device to the first device, group addressed messages;

Step 406: receiving at the second device from the first device group addressed messages that the first device has originated; and

Step 408: forwarding the group addressed messages originated by the first device, to another wireless peer mesh device in the network that the second device has selected as its sole source for group addressed messages.

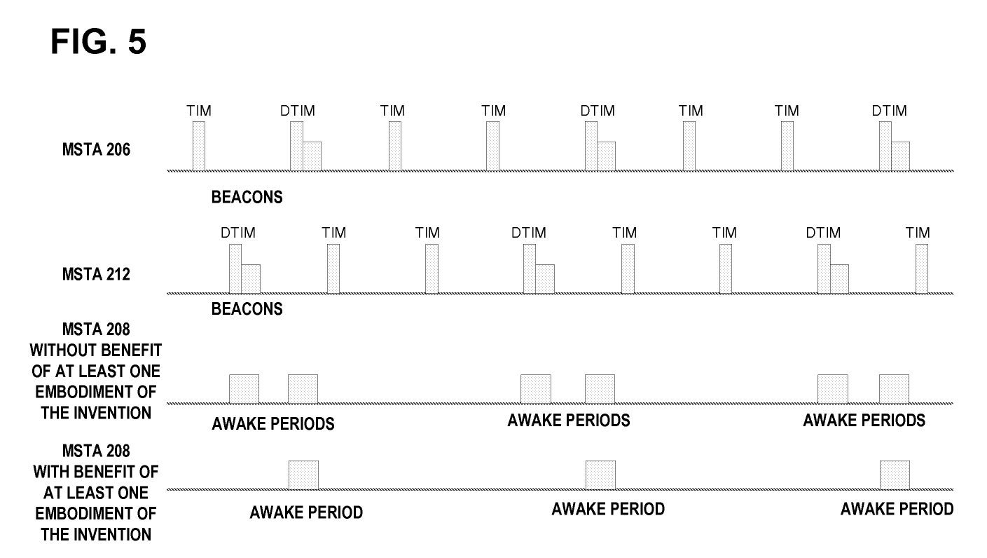

FIG. 5 is an example timing diagram illustrating awake periods of a wireless mesh device MSTA 208 operating without benefit of at least one embodiment of the invention and alternately operating with benefit of at least one embodiment of the invention, enabling MSTA 208 to be awake only for the Delivery Traffic Indication Message (DTIM) Beacons and subsequent group addressed messages from its selected source MSTA 206 of the group addressed messages. FIG. 5 includes timing diagrams for MSTA 206, MSTA 208 and MSTA 212 of FIG. 2A, all of which are operating in the power save mode in this example. If one or more peer devices is in power save mode, each device is required to transmit group addressed frames after its own DTIM beacon.

In FIG. 5, the timing diagram in the top row illustrates the timing of the TIM and DTIM beacons for MSTA 206 of FIG. 2A. Every third beacon is in this example is a DTIM beacon. The blocks following the DTIM beacons illustrate group addressed frame transmissions. The second row illustrates the timing of the TIM and DTIM beacons for MSTA 212 of FIG. 2A. The third row illustrates the timing of the awake periods for MSTA 208 operating without benefit of embodiments of the invention, requiring it to be awake for both the Delivery Traffic Indication Message (DTIM) Beacons and subsequent group addressed messages from MSTA 206 and also to be awake for the Delivery Traffic Indication Message (DTIM) Beacons and subsequent group addressed messages from MSTA 212. The bottom row illustrates the timing of the awake periods for MSTA 208 operating with benefit of embodiments of the invention, enabling MSTA 208 to be awake only for the Delivery Traffic Indication Message (DTIM) Beacons and subsequent group addressed messages from its selected source MSTA 206 of the group addressed messages. MSTA 208 ignores group addressed messages from MSTA 212 that was not selected to be a sole transmitting source to MSTA 208. If MSTA 208 operates in power save mode, it wakes up for the Delivery Traffic Indication Message (DTIM) Beacons and subsequent group addressed messages from its selected source MSTA 206.

The RAM 24 and PROM 26 of FIG. 1 may be removable memory devices such as smart cards, Subscriber Identity Modules (SIMs), Wireless Application Protocol Identity Modules (WIMs), semiconductor memories such as a RAM, ROM, or PROM, flash memory devices, etc. The Medium Access Control (MAC) Layer 36 of the network protocol of the wireless device and/or application program 30 may be embodied as program logic stored in the RAM 24 and/or PROM 26 in the form of sequences of programmed instructions which may be executed in the CPU 22, carry out the functions of the disclosed embodiments. The program logic may be delivered to the writeable RAM, PROM, flash memory device, etc. 24 of the wireless mesh device MSTA 206 from a computer program product or article of manufacture in the form of computer-usable media such as resident memory devices, smart cards or other removable memory devices, or in the form of program logic transmitted over any transmitting medium which transmits such a program. Alternately, the MAC Layer 36 and/or application program 30 may be embodied as integrated circuit logic in the form of programmed logic arrays or custom designed application specific integrated circuits (ASIC). The transceiver 38 in wireless mesh device MSTA 206 operates in accordance with the network protocol of the wireless device. The MAC layer 36 may operate using, for example the IEEE 802.11s standard, for example as specified above.

The several wireless mesh devices shown in the network of FIG. 2A may be mobile communications devices, PDAs, cell phones, laptops or palmtop computers, or the like. The wireless devices may also be integrated components of a vehicle, such as an automobile, bicycle, airplane or other mobile conveyance. The several wireless mesh devices shown in the network of FIG. 2A are typically mobile and are powered by a battery included in the device, whose power needs to be conserved by the device operating in power save mode.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable medium.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Although specific example embodiments have been disclosed, a person skilled in the art will understand that changes can be made to the specific example embodiments without departing from the spirit and scope of the invention. For instance, the features described herein may be employed in networks other than Wireless LAN networks.

What is claimed is:

1. A method, comprising:
receiving at a first wireless peer mesh device in a wireless mesh network, a portal announcement frame that includes a network address of a portal device in the network and a network address of a second wireless peer mesh device in the network that transmitted the frame to the first device;
selecting with the first device the second device to be a sole transmitting source from which the first device will receive group addressed messages;
transmitting by the first device a group delivery notify message to the second device informing the second device of its selection as the sole transmitting source of group addressed messages for the first device;
receiving at the first device from the second device, group addressed messages; and
ignoring group addressed messages from other devices in the network not selected to be a sole transmitting source to the first device.

2. The method of claim 1, further comprising:
transmitting by the first device to the second device group addressed messages that the first device has originated.

3. The method of claim 1, further comprising:
transmitting by the first device group addressed messages to a third wireless mesh device in the network, which has selected the first device to be a sole transmitting source from which the third wireless mesh device will receive group addressed messages; and
receiving at the first device from the third device group addressed messages that the third device has originated and forwarding those group addressed messages to the second device.

4. The method of claim 1, wherein said selection is based on a quality of a communication path between the first device and the second device.

5. The method of claim 1, wherein said group addressed frames are group addressed using at least one of a multicast or broadcast frame communication in a IEEE 802.11s wireless mesh network.

6. The method of claim 1, wherein said group delivery notify message is a management frame in an IEEE 802.11s wireless mesh network.

7. The method of claim 1, wherein said group delivery notify message is an information element in a mesh path selection frame in an IEEE 802.11s wireless mesh network.

8. The method of claim 1, further comprising:
receiving at the first device, a plurality of portal announcement frames from a plurality of wireless peer mesh devices in the network, the plurality including said second device; and
selecting with the first device the second device to be a sole transmitting source from which the first device will receive group addressed messages, based on a quality of a communication path between the first device and the second device.

9. A method, comprising:
receiving at a second wireless peer mesh device in a wireless mesh network, from a first wireless peer mesh device in the network, a group delivery notify message informing the second device of its selection as a sole transmitting source of group addressed messages for the first device;
transmitting from the second device to the first device, group addressed messages; and
receiving at the second device from the first device group addressed messages that the first device has originated.

10. The method of claim 9, wherein said group delivery notify message is a management frame in an IEEE 802.11s wireless mesh network.

11. The method of claim 9, wherein said group delivery notify message is an information element in a mesh path selection frame in an IEEE 802.11s wireless mesh network.

12. The method of claim 9, further comprising:
forwarding the group addressed messages originated by the first device, to another wireless peer mesh device in the network that the second device has selected as its sole source for group addressed messages.

13. An apparatus, comprising:
at least one processor;
at least one memory including computer program code;
the at least one memory and the computer program code configured to, with the at least one processor, cause the apparatus at least to:
receive a portal announcement frame that includes a network address of a portal device in the network and a network address of a second wireless peer mesh device in the network that transmitted the frame to the apparatus;
select the second device to be a sole transmitting source from which the apparatus will receive group addressed messages;
transmit a group delivery notify message to the second device informing the second device of its selection as the sole transmitting source of group addressed messages for the apparatus;
receive from the second device, group addressed messages; and
ignore group addressed messages from other devices in the network not selected to be a sole transmitting source to the first device.

14. The apparatus of claim 13, further comprising:
the at least one memory and the computer program code configured to, with the at least one processor, cause the apparatus at least to:
transmit by the apparatus to the second device group addressed messages that the apparatus has originated.

15. The apparatus of claim 13, further comprising:
the at least one memory and the computer program code configured to, with the at least one processor, cause the apparatus at least to:
transmit group addressed messages to a third wireless mesh device in the network, which has selected the apparatus to be a sole transmitting source from which the third wireless mesh device will receive group addressed messages; and
receive from the third device group addressed messages that the third device has originated and forwarding those group addressed messages to the second device.

16. The apparatus of claim 13, wherein said selection is based on a quality of a communication path between the first device and the second device.

17. The apparatus of claim 13, wherein said group addressed frames are group addressed using at least one of a multicast or broadcast frame communication in an IEEE 802.11s wireless mesh network.

18. The apparatus of claim 13, wherein said group delivery notify message is a management frame in an IEEE 802.11s wireless mesh network.

19. The apparatus of claim 13, wherein said group delivery notify message is an information element in a mesh path selection frame in an IEEE 802.11s wireless mesh network.

20. The apparatus of claim 13, further comprising:
the at least one memory and the computer program code configured to, with the at least one processor, cause the apparatus at least to:
receive a plurality of portal announcement frames from a plurality of wireless peer mesh devices in the network, the plurality including said second device; and
select the second device to be a sole transmitting source from which the apparatus will receive group addressed messages, based on a quality of a communication path between the apparatus and the second device.

21. An apparatus, comprising:
at least one processor;
at least one memory including computer program code;
the at least one memory and the computer program code configured to, with the at least one processor, cause the apparatus at least to:
receive from a first wireless peer mesh device in the network, a group delivery notify message informing the apparatus of its selection as a sole transmitting source of group addressed messages for the first device;
transmit from the apparatus to the first device, group addressed messages; and
receive at the apparatus from the first device group addressed messages that the first device has originated.

22. The apparatus of claim 21, wherein said group delivery notify message is a management frame in an IEEE 802.11s wireless mesh network.

23. The apparatus of claim 21, wherein said group delivery notify message is an information element in a mesh path selection frame in an IEEE 802.11s wireless mesh network.

24. The apparatus of claim 21, further comprising:
the at least one memory and the computer program code configured to, with the at least one processor, cause the apparatus at least to:
forward the group addressed messages originated by the first device, to another wireless peer mesh device in the network that the apparatus has selected as its sole source for group addressed messages.

25. A computer readable medium storing program instructions, which when executed by a computer processor, perform the steps comprising:
receiving at a first wireless peer mesh device in a wireless mesh network, a portal announcement frame that includes a network address of a portal device in the network and a network address of a second wireless peer mesh device in the network that transmitted the frame to the first device;
selecting with the first device the second device to be a sole transmitting source from which the first device will receive group addressed messages;
transmitting by the first device a group delivery notify message to the second device informing the second device of its selection as the sole transmitting source of group addressed messages for the first device;
receiving at the first device from the second device, group addressed messages; and
ignoring group addressed messages from other devices in the network not selected to be a sole transmitting source to the first device.

26. A computer readable medium storing program instructions, which when executed by a computer processor, perform the steps comprising:
receiving at a second wireless peer mesh device in a wireless mesh network, from a first wireless peer mesh device in the network, a group delivery notify message informing the second device of its selection as a sole transmitting source of group addressed messages for the first device;
transmitting from the second device to the first device, group addressed messages; and
receiving at the second device from the first device group addressed messages that the first device has originated.

27. The method of claim 1, further comprising:
receiving at the first device a group delivery notify message from a third wireless mesh device in the network, which has selected the first device to be a sole source from which the third device will receive group addressed messages;
stopping ignoring group addressed messages received by the first device from the third device in response to receiving the group delivery notify message from the third device;
transmitting by the first device to the third device group addressed messages moving in a direction away from the portal device; and
receiving at the first device from the third device group addressed messages that the third device has originated or which are moving in the direction toward the portal device and forwarding those group addressed messages to the second device.

28. The apparatus of claim 13, further comprising:
the at least one memory and the computer program code configured to, with the at least one processor, cause the apparatus at least to:
receive at the first device a group delivery notify message from a third wireless mesh device in the network, which has selected the first device to be a sole source from which the third device will receive group addressed messages;
stop ignoring group addressed messages received by the first device from the third device in response to receiving the group delivery notify message from the third device;
transmit by the first device to the third device group addressed messages moving in a direction away from the portal device; and
receive at the first device from the third device group addressed messages that the third device has originated or which are moving in the direction toward the portal device and forwarding those group addressed messages to the second device.
